(19) United States
(12) Patent Application Publication
(10) Pub. No.: US 2011/0117923 A1
(43) Pub. Date: May 19, 2011

(54) SYSTEM FOR MONITORING POSITIONS OF MOVING OBJECT

(76) Inventors: Shoichiro Yonezawa, Tokyo (JP); Junko Yonezawa, Tokyo (JP)

(21) Appl. No.: 12/443,759

(22) PCT Filed: Jun. 1, 2007
(86) PCT No.: PCT/JP2007/061210

§ 371 Date: Dec. 6, 2010

(30) Foreign Application Priority Data
Oct. 2, 2006 (JP) 2006-270517

(51) Int. Cl. H04W 64/00

(52) U.S. Cl. 455/456.1

(57) ABSTRACT

[PROBLEMS TO BE SOLVED] A problem to be solved is to provide a moving object monitoring system that can confirm a position of a moving object including a person in a complicated pit in order to early discover a trouble or a problem occurring in the pit. [MEANS FOR SOLVING PROBLEMS] In the moving object position monitoring system is comprised of a moving object central monitoring means, mobile stations and pit base means. The moving object central monitoring means is characterized in that the moving object central monitoring means is made to store a set position of each pit base means in advance and to display a position of each mobile station in the pit in accordance with position information transmitted from each pit base means.

### TECHNICAL FIELD

The present invention relates to a system for monitoring positions of moving objects such as persons staying underground in a coal mine, a road tunnel or the like.

### BACKGROUND ART

Access control systems for controlling persons entering and exiting from an underground structure such as a coal mine, a road tunnel or the like in order to ensure the safety of workers are known (refer to Patent Document 1).

Such access control systems are so designed that each person entering and exiting from an underground structure is made to bear an identification card for transmitting a radio signal of a specific frequency and a transmission/reception means for receiving a specific frequency transmitted from the identification card is arranged at the entrance/exit of the underground structure so as to control the person entering or exiting the structure according to the specific frequency received by the transmission/reception means.

Patent Document 1: Japanese Patent No. 2,743,040

### DISCLOSURE OF THE INVENTION

### Problem to Be Solved by the Invention

Known access control systems as described above are suitable for securing safety of the workers staying in an underground structure because the system can accurately and immediately tell the person or persons remaining in the underground structure if a disastrous accident takes place in the structure.

However, known access control system can only grasp the entrance to and exit from an underground structure of each person. In other words, such systems can tell if there is a person or are persons left in the underground structure when an accident occurs but they are accompanied by a problem that they cannot tell where the person is or the persons are actually found in the structure.

Particularly, in the case of a coal mine, galleries extend in a complicated manner and hence the person or persons left in the coal mine cannot be detected quickly according to the information telling only that there is a person or are persons, whichever appropriate, left in the mine.

Additionally, known access control systems of simply controlling a person or persons entering and exiting from an underground structure cannot cope with a situation where a worker becomes physically ill or mistakenly gets into a wrong gallery.

In view of the above-identified problems of the prior art, the inventors of the present invention make it an object of the invention to provide a system for monitoring positions of moving objects that can locate moving objects including human beings in an underground structure so as to be able to quickly detect any accident or problem that takes place in a complicated underground structure.

### Means for Solving the Problem

According to the present invention, the above object is achieved by providing a system for monitoring positions of moving objects characterized in that the system includes: a central moving object monitoring means arranged out of an underground structure; mobile stations to be borne by respective human beings and/or some other moving objects; and at least an underground base means arranged within a control region in the underground structure, that each of the mobile stations is made to store in advance a specific piece of mobile station identification information and transmit the mobile station identification information of itself at regular time intervals as digital signal, that the or each of the underground base means is made to store in advance a specific piece of base station identification information, receive the specific pieces of mobile station identification information transmitted from the mobile stations and transmit the received pieces of mobile station identification information and the base station identification information of itself to the central moving object monitoring means as positional information; and that the central moving object monitoring means is made to store in advance the positions of installation of the underground base means and display the position of each of the mobile stations in the underground structure according to the positional information transmitted from the underground base means.

### Advantages of the Invention

As described above, according to the present invention, system for monitoring positions of moving objects includes a central moving object monitoring means arranged out of an underground structure, mobile stations to be borne by respective human beings and/or some other moving objects and at least an underground base means arranged within a control region in the underground structure. Each of the mobile stations is made to store in advance a specific piece of mobile station identification information and transmit the mobile station identification information of itself at regular time intervals as digital signal. The or each of the underground base means is made to store in advance a specific piece of base station identification information, receive the specific pieces of mobile station identification information transmitted from the mobile stations and transmit the received pieces of mobile station identification information and the base station identification information of itself to the central moving object monitoring means as positional information. The central moving object monitoring means is made to store in advance the positions of installation of the underground base means and display the position of each of the mobile stations in the underground structure according to the positional information transmitted from the underground base means. Therefore, the central moving object monitoring means can recognize the underground base means whose sensing area covers a given mobile station according to the positional information transmitted from the underground base means and display the position of the mobile station on a real time basis. With this arrangement, if an accident occurs in the underground structure, for instance, the system provides a remarkable advantage of quickly detecting the workers remaining in the underground structure and rescuing them from there.

Additionally, since the system can grasp the position of each of the workers in the underground structure, it can quickly detect any worker who mistakenly gets into a wrong gallery or a dangerous area to prevent an accident from taking place.

Furthermore, since the system can grasp the position of each of the moving objects such as workers in the underground structure on a real time basis, it can predict the motion of the moving object in the underground structure to a certain extent. Therefore, if a worker becomes physically ill in the underground structure or a work vehicle gets into trouble, the problem can be detected early.

Each of the mobile stations is equipped with a oscillation sensor and adapted to transmit a detection signal of the oscillation sensor in addition to the mobile station identification information, and each of the underground base means is adapted to receive the mobile station identification information and the oscillation sensor detection signal transmitted from the mobile station and transmit the mobile station identification information and the oscillation sensor detection signal it receives and the base station identification information of itself to the central moving objects monitoring means. With this arrangement, the central moving object monitoring means can detect if there is a mobile station that senses any abnormal oscillations in the underground structure or not on a real time basis and locate the mobile station in the underground structure so that the worker and/or the work vehicle in an emergency situation can be rescued quickly.

Each of the mobile stations is equipped with a tilt sensor and adapted to transmit a detection signal of the tilt sensor in addition to the mobile station identification information, and each of the underground base means is adapted to receive the mobile station identification information and the tilt sensor detection signal transmitted from the mobile station and transmit the mobile station identification information and the tilt sensor detection signal it receives and the base station identification information of itself to the central moving object monitoring means. With this arrangement, the central moving object monitoring means can detect if there is a mobile station that is subjected to an abnormal tilt or not on a real time basis and locate the mobile station in the underground structure so that the worker and/or the work vehicle in an emergency situation can be rescued quickly.

Each of the mobile stations is adapted to be able to transmit optional information prepared by combining the mobile station identification number of itself and optional data received by the mobile station, and each of the underground base means is adapted to receive the optional information and transmit the optional information it receives and the base station identification information of itself to the central moving object monitoring means. With this arrangement, any of the workers in the underground structure can transmit optional information to the central moving object monitoring means by way of his or her mobile station.

Each of the mobile stations is adapted to receive only information including the base station identification number of itself, each of the underground base means is adapted to receive only information including the base station identification number of itself, and the central moving object monitoring means is adapted to be able to transmit specific transmission information prepared by combining an arbitrarily selected mobile station identification number, the base station identification information of the underground base means whose sensing area covers the mobile station of the mobile station identification number and optional data. With this arrangement, a manager staying outside the mine can transmit optional data such as information on an occurrence of danger, information on a start of operation or information on an end of operation to an arbitrarily selected mobile station or to all the mobile stations with use of the central moving object monitoring means.

### BEST MODE FOR CARRYING OUT THE INVENTION

Now, an embodiment of system for monitoring positions of moving objects according to the present invention will be described by referring to the accompanying drawings.

FIG. 1 is a schematic illustration of a system for monitoring positions of moving objects according to the present invention, showing the system configuration thereof. FIG. 2 is a schematic block diagram of the system for monitoring positions of moving objects shown in FIG. 1.

As shown in FIGS. 1 and 2, the system for monitoring positions of moving objects includes:
a central moving object monitoring means A arranged outside an underground structure;
an access control means B arranged at the entrance of the underground structure;
a plurality of underground base means C arranged in the underground structure;
mobile stations D shared by workers;
personal registration ID tags E specific to and borne by respective workers; and
mobile station registration ID tags F prepared for the respective mobile stations D.

As shown in FIGS. 1 and 2, the central moving object monitoring means A is provided with a central monitoring unit 1, a data collection unit 10 and a printer 15.

The central monitoring unit 1 is formed typically by using a computer. The central monitoring unit 1 is connected to a keyboard 2, a display (CRT) 3 and an uninterruptible power supply (UPS) 4 and also to an IP phone 6 by way of a communication control unit 5.

The data collection unit 10 is also formed typically by using a computer. The data collection unit 10 is connected to a keyboard 11, a display (CRT) 12 and an uninterruptible power supply (UPS) 13.

The central monitoring unit 1, the data collection unit 10 and the printer 15 are connected to a hub 16 by way of a LAN cable.

The hub 16 is connected to a media converter 17 by way of a LAN cable and the media converter 17 is by turn connected to an optical cable.

The access control means B includes a management terminal unit 20, a Web camera 30, an IP phone 31, a tag reader 32 for reading the information on the tag E borne by each of the workers, a sensor 33 for detecting the moving direction of each of the workers and a remote I/O (input/output means) 34 of the sensor 33.

The management terminal unit 20 is formed typically by using a computer. The management terminal unit 20 is connected to a keyboard 21, a display (CRT) 22 and an uninterruptible power supply (UPS) 23.

The management terminal unit 20, the Web camera 30, the IP phone 31 that can talk with the IP phone 6 of the central moving object monitoring means A, the tag reader 32 and the remote I/O (input/output means) 34 are connected to a hub 35 by way of a LAN cable.

The hub 35 is connected to a media converter 36 by way of a LAN cable and the media converter 36 is by turn connected to an optical cable.

Now, the personal registration ID tag E and the mobile station registration ID tag F will be described briefly below. Each worker is provided with a personal registration ID tag E so that a number of tags E equal to the number of the workers are prepared. However, a mobile station D is to be operated only it is put into the underground structure and each worker is not provided with a mobile station D. In other words, the number of mobile stations available for the underground structure may more often than not smaller than the number of the workers.

Therefore, while the tag information of each personal registration ID tag E and the personal information of the corresponding worker (the name of the worker, etc.) is associated with each other, mobile station registration ID tags F that are associated with the respective mobile stations D are prepared because there is no knowing which worker carries which mobile station D when entering the underground structure.

The access control means B receives the tag information of the personal registration ID tag E that is borne by a worker and the tag information of the mobile station registration ID tag F that is carried by the worker by way of the tag reader 32 and associates the two pieces of tag information (the worker registration ID and the mobile station registration ID) with each other.

Additionally, the access control means B detects the moving direction of each worker according to the detection information from the sensor 33. To be accurate, the sensor 33 includes two proximity sensor pairs 33a and 33b as shown in FIG. 3. When a worker passes by one of the proximity sensor pairs, or the proximity sensor pair 33a, that is located remote from the underground structure and then by the other proximity sensor pair 33b that is located close to the underground structure, the access control means B determines that the worker is entering the underground structure.

The access control means B determines the other way round in an opposite situation.

FIG. 4 is a flowchart of the entrance management process of the access control means B.

As shown in FIG. 4, the management terminal unit 20 of the access control means B monitors if a detection signal from the sensor pair 33a is input or not (Step 1).

As the management terminal unit 20 receives a detection signal from the sensor pair 33a, it reads in the tag information (the worker registration ID) of the detected personal registration ID tag E by means of the tag reader 32 (Step 2).

Then, the management terminal unit 20 determines if the personal registration ID it reads in is registered in advance in the central monitoring unit 1 of the central moving object monitoring means A or not (Step 3). If the personal registration ID is not registered in advance in the central monitoring unit 1 or if the personal registration ID cannot be read in Step 2, the management terminal unit 20 determines again if the sensor pair 33a detects a signal or not (Step 4). If the sensor pair 33a detects the signal again, the management terminal unit 20 determines that the worker who once intended to enter the underground structure returns without entering the structure and ends the entrance management process.

If no detection signal is input from the sensor pair 33a to the management terminal unit 20, the management terminal unit 20 monitors to see if a detection signal is input from the sensor pair 33b or not (Step 5).

Thereafter, the management terminal unit 20 keeps on monitoring until a detection signal is input either from the sensor pair 33a or from the sensor pair 33b and, when a detection signal is input from the sensor pair 33b, the management terminal unit 20 determines an unauthorized entrance and executes an entrance check process (Step 6).

An entrance check process is a process of turning on the rotary beacon light arranged near the entrance of the underground structure and making it emit red light or turning on the rotary beacon light buzzer arranged at an appropriate position.

After the entrance check process (Step 6), the management terminal unit 20 picks up an image of the unauthorized person trying to enter the underground structure by means of the Web camera 30 and the data on the picked up image are sent to the management terminal unit 20 (Step 7).

If the personal registration ID detected by the tag reader 32 is already registered in advance, the management terminal unit 20 then determines if the worker that corresponds to the personal registration ID has already entered the underground structure or not by referring to “the intra-structure moving history data” registered in the central monitoring unit 1 (Step 8).

The intra-structure moving history data are data on the entrances, the exits and the other moves of all the workers that are sequentially added and registered in the access control means B and the central moving object monitoring means A. The data are recorded in the central monitoring unit 1.

If the management terminal unit 20 determines in Step 8 hat the personal registration ID of the person trying to enter the underground structure is that of a person who has already entered the underground structure, the management terminal unit 20 subsequently monitors if the person trying to enter is actually entering or exiting from the underground structure (Steps 4 and 5) and then executes an entrance check process (Step 6) before it finally picks up an image of the person by means of the Web camera 30 (Step 7).

If the management terminal unit 20 determines in Step 8 that the personal registration ID of the person trying to enter the underground structure does not correspond to any personal registration IDs of the persons who have already entered the underground structure, the management terminal unit 20 then reads in the tag information of the mobile station registration ID Tag F that the person carries (Step 9).

Then, the management terminal unit 20 sees if the mobile station registration ID it reads in is registered in the central monitoring unit 1 in advance or not by collation (Step 10) and, if it is determined that the mobile station registration ID is not registered in the central monitoring unit 1, it subsequently monitors if the person trying to enter is actually entering or exiting from the underground structure (Steps 4 and 5) and then executes an entrance check process (Step 6) before it finally picks up an image of the person by means of the Web camera 30 (Step 7).

If, on the other hand, the management terminal unit 20 determines in Step 10 that the mobile station registration ID it reads in is registered in advance, it then monitors the person until a detection signal is input either from the sensor pair 33a or from the sensor pair 33b (Steps 11 and 12) and, when a detection signal is input from the sensor pair 33a once again, it determines that the person goes to the outside of the underground structure without entering the underground structure and returns to the process of Step 1. Conversely, when a detection signal is input from the sensor pair 33b, the management terminal unit 20 determines that the person is trying to enter the underground structure and associates the personal registration ID and the mobile station registration ID (Step 13). Then, after executing an entrance permission process (Step 14), the management terminal unit 20 additionally registers the fact that the personal registration ID and the mobile station registration ID entered the underground structure along with the time of entrance to the intra-structure moving history data (Step 15).

An entrance permission process is a process of turning on the rotary beacon light arranged near the entrance of the underground structure and making it emit green light.

FIG. 5 is a flowchart of the exit management process of the access control means B. As shown in FIG. 5, the management terminal unit 20 of the access control means B monitors to see if a signal from the sensor pair 33b is input or not (Step 1)

As the management terminal unit 20 receives a detection signal from the sensor pair 33b, it reads in the tag information (the worker registration ID) of the detected personal registration ID tag E by means of the tag reader 32 (Step 2).

Then, the management terminal unit 20 determines if the personal registration ID it reads in has entered the underground structure and remains there or not by referring to the intra-structure moving history data (Step 3).

If the management terminal unit 20 determines that the personal registration ID it reads in has not entered the underground structure or if the personal registration ID cannot be read in Step 2, it determines that the exit is unauthorized and executes an exit check process (Step 4). Then, it also picks up an image of the person trying to make an unauthorized exit by means of the Web camera 30 (Step 5) and the data on the picked up image are sent to the management terminal unit 20.

An exit check process is a process of turning on the rotary beacon light arranged near the entrance of the underground structure and making it emit red light or turning on the rotary beacon light buzzer arranged at an appropriate position.

Thereafter, the management terminal unit 20 monitors until a detection signal is input again from the sensor pair 33b or a detection signal is input from the sensor pair 33a (Steps 6 and 7) and ends the process when a detection signal is input either from the sensor pair 33b or from the sensor pair 33a.

If the management terminal unit 20 determines in Step 3 that the personal registration ID of the person trying to exit from the underground structure has entered the underground structure and remains there, then it reads in the tag information (the mobile station registration ID) of the mobile station registration ID tag F that the person carries (Step 8).

Thereafter, the management terminal unit 20 sees if the combination of the mobile station registration ID and the personal registration ID it reads in is same as the combination registered in the intra-structure moving history data at the time of entrance or not by collation (Step 9). If it is determined that the combination of the mobile station registration ID and the personal registration ID is not same as the combination registered at the time of entrance, the management terminal unit 20 subsequently monitors until a detection signal is input again from the sensor pair 33b or a detection signal is input from the sensor pair 33a (Steps 10 and 11). If a detection signal is input from the sensor pair 33b or 33a, it forcibly annuls the association of the mobile station registration ID and the personal registration ID (Step 12) and then executes an exit check process (Step 13) before it finally picks up an image of the person by means of the Web camera 30 (Step 14).

Note that the worker whose position cannot be monitored as moving object any longer as a result of forcibly annulling the association of the mobile station registration ID and the personal registration ID is subsequently controlled for entrance and exit only according to the intra-structure moving history data.

If the management terminal unit 20 determines that the combination of the mobile station registration ID and the personal registration ID it reads in Step 9 is same as the combination registered to the intra-structure moving history data at the time of entrance, it monitors until a detection signal is input either from the sensor pair 33a or from the sensor pair 33b (Steps 15 and 16) and, when a detection signal is input again from the sensor pair 33b, it determines that the person returns into the underground structure without exiting from it and continues the process of monitoring the position of the moving object for the person. When, on the other hand, a detection signal is input from the sensor pair 33a, the management terminal unit 20 determines that the person is trying to exit from the underground structure and annuls the association of the personal registration ID and the mobile station registration ID (Step 17). Then, the management terminal unit 20 executes an exit permission process (Step 18) and substantially registers that the personal registration ID and the mobile station registration ID exit from the underground structure along with the time of exit to the intra-structure moving history data (Step 19).

An exit permission process is a process of turning on the rotary beacon light arranged near the entrance of the underground structure and making it emit green light.

Note that, while all the workers may be provided with respective mobile stations D, the arrangement of this embodiment can minimize the number of mobile stations (to the number of the workers entering the underground structure at the same time).

While personal registration ID tags E and mobile station registration ID tags F are prepared and the personal registration ID and the mobile station registration ID obtained from the tags that a worker bears are associated with each other so as to associate the worker bearing those tags with the mobile station in the above-described embodiment, the technique of associating a worker and a mobile station is not limited to the above-described one. In other words, any alternative technique may be employed so long as it can associate a worker and the mobile station that the worker carries when entering the underground structure. For example, an underground base means C may be arranged near the entrance of the underground structure in order to detect the mobile station identification information of the mobile station D that a worker carriers so that it may be associated with the personal registration ID of the worker detected by the access control means B. Alternatively, the access control means B may be provided with an input means by way of which the mobile station identification information of the mobile station D that a worker carriers can be input so that the worker him- or herself or the manager of the worker may input the mobile station identification number that the worker carries at the access control means B when the worker enters the underground structure so as to associate the worker with the tag information.

Each of the underground base means C that are arranged in the underground structure includes an underground base station 40, a gas detection sensor 50 and a monitor camera 51 as shown in FIG. 2.

The underground base station 40 is connected to a hub 52 by way of a LAN cable and the gas detection sensor 50 and the monitor camera 51 are also connected to the hub 52 by way of a remote I/O 53 and a LAN cable.

The hub 52 is connected to a media converter 54 by way of a LAN cable and the media converter 54 is connected to an optical cable.

The underground base stations 40 are connected to each other by way of optical cables. Preferably, however, the underground base stations 40 are connected to each other not in series but by branch connections or the optical cables are duplicated so that the trouble of any of the underground base stations 40 may not adversely affect the communications of the remaining underground base stations 40.

FIG. 6 is a schematic block diagram of an underground base station 40, showing the internal configuration thereof.

The underground base station 40 includes:

an 8-bit CPU 41;

a unique format wireless transmitter/receiver set 42 for wirelessly communicating with each of the mobile stations D at 400 MHz with a unique format; and

a power supply having a regulator 43, a lithium battery 44 and a charging circuit 45.

The CPU 41 includes a built-in flash ROM 41a, a built-in RAM 41b, a wired interface 41c for connecting the underground base station to the hub 52 and a wireless interface 41d for the wireless transmitter/receiver set 42.

FIG. 7 is a schematic block diagram of a mobile station D to be carried by a worker entering the underground structure, showing the internal configuration thereof.

The mobile station D includes:

an 8-bit CPU 60;

a unique format wireless transmitter/receiver set 61 for wirelessly communicating with each of the other mobile stations D at 400 MHz with a unique format;

an LED 62, a switch 63, a buzzer 64, an oscillation sensor 65, a tilt sensor 66 and other man-machine interface 67; and

a power supply having a regulator 68, a lithium battery 69 and a charging circuit 70.

The CPU 60 includes a built-in flash ROM 60a, a built-in RAM 60b, a wireless interface 60c for the wireless transmitter/receiver set 61 and a standard input/output port 60d for the man-machine interface 67 and so on.

The mobile station D additionally includes an oscillator 71.

With the above arrangement, the underground base means C is connected to the central moving object monitoring means A and the access control means B that are arranged outside the underground structure by way of optical cables and data is transmitted and received between the underground base means C and the mobile stations D.

Each of the underground base means C is installed at a predetermined position in the underground structure as shown in FIG. 8. FIG. 8 illustrates an installation example of the underground base means C in the underground structure.

In FIG. 8, reference symbol C1 denotes the underground base station installed for detection at a passing point (to be referred to as “underground base station for a passing point” hereinafter) ;
reference symbol C2 denotes the underground base stations installed in areas where workers frequently enter and exit (to be referred to as management areas hereinafter) (to be referred to as “underground base stations for management areas” hereinafter) ; and
reference symbol C3 denotes the underground base stations installed at the entrances/exits of the management areas (to be referred to as “underground base stations for entrance/exit of management areas” hereinafter).

A plurality of underground base stations for management areas are installed at regular intervals so as to cover the entire management areas, taking the coverage of the antenna of the wireless transmitter/receiver set 42 of each base station 40. Three underground base means C2 are arranged at intervals of 20m in each management area in the instance of FIG. 8 because the coverage of the antenna of each base station is 10 m in terms of radius. Of course, the coverage of the antenna of each base station can be selected appropriately typically within a range between 10 m and 50 m. Therefore, the installation intervals of the underground base means C2 in the management areas can be modified appropriately according to the coverage of the antenna.

The way in which underground base stations are installed is not limited to that of the example of FIG. 8 and may alternatively be installed so as to make the antennas of the wireless transmitter/receiver sets 42 of the base stations cover the entire area of the underground structure, taking the coverage of the antenna of the wireless transmitter/receiver set 42 of each base station 40. However, the arrangement of FIG. 8 can minimize the number of underground base stations C.

Thus, the system for monitoring positions of moving objects having the above-described configuration
controls the entrances to and exits from the underground structure of workers by the access control means B and, at the same time,
monitors the positions of the workers carrying respective mobile stations D in the underground structure by means of the central moving object monitoring means A as
the base station 40 of each of the underground base means C receives the information transmitted periodically from each of the mobile stations D carried by a worker who have entered the underground structure and
each of the underground base means C that receives the information then transmits the received information periodically to the central moving object monitoring means A arranged outside the underground structure by way of an optical cable.

A specific identification number (base station identification number) is assigned to each of the underground base means C and the built-in flash ROM 41a of the base station 40 stores in advance the base station identification number.

The place of installation of each of the underground base means C in the underground structure and the base station identification number of the underground base means C are registered in advance to the central monitoring unit 1 of the central moving object monitoring means A. The central monitoring unit 1 can display the place of installation of each of the underground base means C and the base station identification number thereof on the management chart (map or the like) of the underground structure that is also registered in advance through the display 3 base on the registered information.

A specific identification number (mobile station identification number) is assigned to each of the mobile stations D and the built-in flash ROM 60a of the mobile station D stores in advance the base station identification number.

Then, the CPU 60 of each of the mobile stations D automatically transmits the mobile station identification number of its own as digital signal at predefined time intervals (which predefined intervals can be adjusted appropriately) through the transmitter/receiver set 61.

As the underground base means C that senses the signal transmitted from the mobile station D receives the mobile station identification number transmitted from the base station D, the CPU 41 of the underground base means C then transmits positional information including the mobile station identification number and the base station identification number of its own to the central moving object monitoring means A by way of an optical cable (see FIG. 9). In the following, the positional information (the mobile station identification number +the base station identification number) transmitted periodically from the underground base means C is referred to as “periodically transmitted positional information”.

The periodically transmitted positional information (the mobile station identification number +the base station identification number) transmitted from each underground base means C is received by the data collection unit 10. Then, the data collection unit 10 registers the “current position data” of the mobile station D that corresponds to the periodically transmitted positional information along with the time of reception of the periodically transmitted positional information in the central monitoring unit 1 according to the information.

Additionally, the data collection unit 10 determines if the mobile station D that corresponds to the periodically transmitted positional information is moving or not according to the periodically transmitted positional information and, if the mobile station D is moving, registers the positional information at that time to the central monitoring unit 1 as “intra-structure moving history data” along with the time of reception of the periodically transmitted positional information.

The central monitoring unit 1 displays, based on the registered “current position data”, mobile station identification information of the mobile stations D that are found within the coverage of each of the underground base means C on the management chart of the underground structure that is registered in advance by means of the display 3.

If necessary, the central monitoring unit 1 can display the names of the workers carrying the respective mobile stations instead of or along with the mobile station identification information according to the personal information (names, etc.) of the workers that correspond to the personal registration IDs associated with the respective mobile station registration IDs by the access control means B and the mobile station identification information on the display 3.

Now, the monitoring process of the positions of the mobile stations D, or the process of monitoring the positions of moving objects, that is executed by the above-described central moving object monitoring means A will be described below by referring to FIGS. 10 through 13.

The central moving object monitoring means A parallely executes the processes of FIGS. 10 through 13 for each of the mobile stations D that have entered the underground structure and have not exited from there.

In the following, the process of monitoring the positions of moving objects will be described in terms of a mobile station out of a plurality of mobile stations D (to be referred to as mobile station D1 hereinafter).

FIG. 10 is a main flowchart of the process of monitoring the positions of moving objects.

The data collection unit 10 of the central moving object monitoring means A monitors the presence or absence of reception of periodically transmitted positional information from each of the underground base stations C that may include mobile station identification information of the mobile station D1 that has already entered the underground structure (Step 1).

The data collection unit 10 finishes reading the periodically transmitted positional information when it successively receives the periodically transmitted positional information that includes a same base station identification member for the mobile station D1 (Step 2).

Particularly, underground base stations are arranged in management areas so as to cover all the management areas. Therefore, when a worker is at the middle position of two adjacent underground base stations, the both underground base stations can receive the information periodically transmitted from the mobile station D being carried by the worker and transmit periodically transmitted positional information that includes the same mobile station identification number simultaneously. Therefore, if the data collection unit 10 is so designed as to update the current position of the mobile station in response to the reception of a single periodically transmitted positional information and a worker is at the middle position of two adjacent underground base stations, the worker's current position may shift frequently to consequently degrade the reliability of the process of monitoring the positions of moving objects.

Additionally, as the electric wave propagating in the underground structure is reflected, an underground base station that is remote from the mobile station and is not supposed to receive the original electric wave may receive the mobile station identification information transmitted from the worker's mobile station. Then, again, the worker's current position may shift frequently to consequently degrade the reliability of the process of monitoring the positions of moving objects.

However, this embodiment can avoid the problem that the worker' s current position shifts frequently because the worker is at the middle point of two adjacent underground base stations or a remote underground base station that is not supposed to receive the electric wave transmitted from the worker's mobile station receives the mobile station identification information because it is so arranged that the data collection unit 10 finishes reading periodically transmitted positional information when it successively receives the periodically transmitted positional information that includes a same base station identification number for a mobile station D.

As the data collection unit 10 finishes reading the periodically transmitted positional information including the same base station identification number for the mobile station D1, it determines the attribute of the underground base station C that transmits the periodically transmitted positional information it finishes reading (Step 3). The attribute of the underground base station C is “for a passing point”, “for management areas” or “for entrance/exit of management areas” as described above.

If the data collection unit 10 determines in Step 3 that the attribute of the underground base station C that transmits the periodically transmitted positional information it finishes reading is “for a passing point” or “ for entrance/exit of management areas”, it does not execute the process of Step 4 and proceeds directly to Step 5. If, on the other hand, the data collection unit 10 determines in Step 3 that the attribute of the underground base station C that transmits the periodically transmitted positional information it finishes reading is “for management areas”, it then checks if the base station is a properly matching station or not (Step 4).

It is determined in Step 4 that the base station is a properly matching station or not according to if the reading of the periodically transmitted positional information for the mobile station D1 that is transmitted from an underground base station other than either of the underground base stations located adjacent to the underground base station that transmits the periodically transmitted positional information according to which its attribute is to be determined is finished within a predetermined time or not.

More specifically, if the reading of the periodically transmitted positional information for the same mobile station D transmitted from an underground base station other than either of the underground base stations located adjacent to the underground base station that transmits the periodically transmitted positional information according to which its attribute is to be determined is finished within a predetermined time, the data collection unit 10 determines that the periodically transmitted positional information transmitted from an underground base station other than either of the adjacent underground base stations is unreliable periodically transmitted positional information received due to an unexpected electric wave propagating condition caused by reflections in the underground structure and cancels the periodically transmitted positional information of which it determines completion of the reading in Step 2 so as to return to Step 1.

If, to the contrary, the reading of the periodically transmitted positional information for the same mobile station D transmitted from an underground base station other than either of the underground base stations located adjacent to the underground base station that transmits the periodically transmitted positional information according to which its attribute is to be determined is not finished within a predetermined time, the data collection unit 10 determines that the periodically transmitted positional information is proper periodically transmitted positional information because it is received in a proper signal receiving condition and then moves to the process of the next step, or Step 5.

In Step 5, the status of the mobile station D1 for which the reading of the periodically transmitted positional information is finished is checked.

More specifically, the status of the mobile station D may be a status of “no motion/abnormal” or a status of “abnormal battery operation”.

As for the status of “no motion/abnormal”, the data collection unit 10 determines if the mobile station D is oscillating for a predetermined time or not according to the intra-structure moving history data and then it determines that the mobile station is in a status of no motion/abnormal when it is not oscillating for a predetermined time.

As for the status of “abnormal battery operation”, the data collection unit 10 determines if the status of abnormal battery operation exists or not according to the battery abnormality information transmitted from the base station D. Note that the CPU 60 of each mobile station D constantly monitors its own battery voltage and transmits “battery abnormality information” when it determines that the battery voltage is abnormal. The battery abnormality information is transmitted to the data collection unit 10 by way of the corresponding underground base station.

If the data collection unit 10 determines in Step 5 that the mobile station D is in an abnormal status, it modifies the “worker status data” stored in the central monitoring unit 1 (Step 6). Additionally, if the mobile station D shows an abnormal status, the central monitoring unit 1 displays the abnormal status on the display 3.

More specifically, if the central monitoring unit 1 displays the position of each of the mobile stations D by means of a graphic symbol such as a circle or a quadrangle, the central monitoring unit 1 can display the abnormal status of the mobile station displaying the graphic symbol showing the position of the mobile station D in an abnormal status in a color different from the color showing a normal status.

Additionally, if the central monitoring unit 1 displays the position of each of the underground base stations by means of a graphic symbol such as a circle or a quadrangle, the central monitoring unit 1 can display the abnormal status by displaying the graphic symbol of the underground base station that covers the mobile station D in an abnormal status in a color different from the color showing a normal status.

Still additionally, if the central monitoring unit 1 displays the position of each of the management areas by means of a graphic symbol such as a circle or a quadrangle on the display 3, the central monitoring unit 1 can display the abnormal status by displaying the graphic symbol of the management area to which the underground base station covering the mobile station D in an abnormal status belongs in a color different from the color showing a normal status.

After ending the process of Step 5 and/or Step 6, the data collection unit 10 determines once again the attribute of the underground base station that corresponds to the periodically transmitted positional information it finishes reading (if the underground base station is for a passing point, for management areas or for entrance/exit of management areas) (Step 7).

Then, if the attribute of the underground base station is “for a passing point”, the data collection unit 10 compares “the current position data” of the mobile station D1 registered to the central monitoring unit 1 last time and “the current position (or the position of the corresponding underground base station)” in the periodically transmitted positional information it finishes reading (Step 8).

If the current position of the mobile station D1 is shifted as a result of the comparison in Step 8, the data collection unit 10 additionally registers the current position information at that time to “the intra-structure moving history data” along with the time of reception of the periodically transmitted positional information (Step 9) and then registers “the current position data” (Step 10). If, on the other hand, the current position of the mobile station D1 is not shifted, the data collection unit 10 simply registers “the current position data” without additionally registering anything to “the intra-structure moving history data”

(Step 10).

If the data collection unit 10 determines in Step 7 that the attribute of the underground base station is “for entrance/exit of management areas”, it executes a process for entrance/exit of management areas as shown in FIG. 11. If, on the other hand, the data collection unit 10 determines in Step 7 that the attribute of the underground base station is “for management areas”, it executes a process for management areas as shown in FIG. 12.

Now, the process for entrance/exit of management areas will be described below. FIG. 11 is a flowchart of the process for entrance/exit of management areas.

The data collection unit 10 of the central moving object monitoring means A executes the process for entrance/exit of management areas shown in FIG. 11 when it determines in Step 7 of the main flowchart of FIG. 10 that the attribute of the underground base station is “for entrance/exit of management areas”.

In the process for entrance/exit of management areas, the data collection unit 10 firstly compares “the current position (or the position of the corresponding underground base station)” in the periodically transmitted positional information for the mobile station D1 it finishes reading as shown in the main flowchart with “the current position data” registered to the central monitoring unit 1 last time (Step S1-1).

Then, if the current position of the mobile station D1 is not shifted, the data collection unit 10 registers “the current position (or the position of the corresponding underground base station)” in the periodically transmitted positional information it finishes reading as updated “current position data” (Step S1-5). If the data collection unit 10 determines in Step S1-1 that the current position of the mobile station D1 is shifted, it then determines if the current position data of the mobile station D1 that is registered last time indicates a position in the management area that corresponds to the underground base station for entrance/exit of management areas that transmits the periodically transmitted positional information or not (Step S1-2).

If the data collection unit 10 determines in Step S1-2 that the current position data of the mobile station D1 that is registered last time does not indicate a position in the management area that corresponds to the underground base station for entrance/exit of management areas that transmits the periodically transmitted positional information, it then registers “the current position (or the position of the corresponding underground base station)” in the periodically transmitted positional information as updated “current position data” (Step S1-5).

If, on the other hand, the data collection unit 10 determines in Step S1-2 that the current position data of the mobile station D1 that is registered last time indicates a position in the management area that corresponds to the underground base station for entrance/exit of management areas that transmits the periodically transmitted positional information, it then determines that the mobile station D1 is going out of the management area and computes the sojourn time of the mobile station D1 in the management area based on the “intra-structure moving history data” so as to register the sojourn time to the central monitoring unit 1 (Step S1-3). After registering the sojourn time, the data collection unit 1 adds the current position information at the time to the intra-structure moving history data along with the time of reception of the periodically transmitted positional information in order to update the intra-structure moving history data (Step S1-4) and registers “the current position (or the position of the corresponding underground base station)” in the periodically transmitted positional information as updated “current position data” (Step S1-5).

Now, the process for management areas will be described below. FIG. 12 is a flowchart of the process for management areas.

When the data collection unit 10 determines in Step 7 of the main flowchart of FIG. 10 that the attribute of the underground base station is “for management areas”, it executes the process for management areas as shown in FIG. 12.

In the process for management areas, the data collection unit 10 firstly compares “the current position (or the position of the corresponding underground base station) ” in the periodically transmitted positional information for the mobile station D1 it finishes reading as shown in the main flowchart with “the current position data” registered to the central monitoring unit 1 last time (Step S2-1).

Then, if the current position of the mobile station D1 is not shifted, the data collection unit 10 registers “the current position (or the position of the corresponding underground base station) ” in the periodically transmitted positional information it finishes reading as updated “current position data” (Step S2-4).

If the data collection unit 10 determines in Step S2-1 that the current position of the mobile station D is shifted, it then determines if the current position data of the mobile station D1 that is registered last time indicates a position in the management area that corresponds to the underground base station for management areas or a position that corresponds to the underground base station for entrance/exit of management areas of the management area (Step S2-2).

If the data collection unit 10 determines in Step S2-2 that the current position data of the mobile station D1 that is registered last time indicates a position in the management area that corresponds to the underground base station for management areas, it then registers “the current position (or the position of the corresponding underground base station)” in the periodically transmitted positional information as updated “current position data” (Step S2-4).

If, on the other hand, the data collection unit 10 determines in Step S2-2 that the current position data of the mobile station D1 that is registered last time indicates a position that corresponds to the underground base station for entrance/exit of management areas of the management area, it determines that the mobile station D1 enters the management area and additionally registers the current position information at the time to the intra-structure moving history data along with the time of reception of the periodically transmitted positional information (Step S2-3). Subsequently, the data collection unit 10 registers “the current position (or the position of the corresponding underground base station)” in the periodically transmitted positional information it finishes reading as updated “current position data” (Step S2-4)

Apart from the above-described processes of FIGS. 10 through 12, the data collection unit 10 executes a missing worker monitoring process as shown in FIG. 13.

FIG. 13 is a flowchart of the missing worker monitoring process.

If the central monitoring unit 1 does not receive periodically transmitted positional information from the mobile station D1 in Step 1 of the process of monitoring the positions of moving objects of FIG. 10, it executes the missing worker monitoring process.

In the missing worker monitoring process, the data collection unit 10 firstly determines if the last position of the mobile station D1 is in the management areas or not according to the intra-structure moving history data or the current position data registered to the central monitoring unit 1 (Step S3-1).

If it is determined that the last position of the mobile station D1 is not in the management areas, the data collection unit 10 ends the missing worker monitoring process.

If, on the other hand, it is determined in Step S3-1 that the last position of the mobile station D1 is in the management areas, the data collection unit 10 computes the time elapsed from the time of the reception of the last periodically transmitted positional information relating to the mobile station D1 to the current time according to the intra-structure moving history data registered to the central monitoring unit 1 (Step S3-2).

Then, the data collection unit 10 determines if the elapsed time that is computed in Step S3-2 exceeds a predetermined time or not (Step S3-3) and ends the missing worker monitoring process when the elapsed time does not exceeds the predetermined time. If, on the other hand, the data collection unit 10 determines in Step S3-3 that the elapsed time exceeds the predetermined time, it executes a worker retrieval process (Step S3-4).

In the worker retrieval process (Step S3-4), the data collection unit 10 makes each of the underground base stations and the mobile station D1raise the transmission output power thereof and tries to receive worker retrieval response information under the condition of raised transmission output power.

If worker retrieval response information is received at least once in a state where the worker retrieval process is being executed, the data collection unit 10 determines that the mobile station D1 (the worker) is detected according to the worker retrieval response information.

As the data collection unit 10 receives the worker retrieval response information that includes the mobile station identification information of the mobile station D1 in the worker retrieval process, it determines that the mobile station D1 is detected (Step S3-5) and registers the current position of the mobile station D1 according to the periodically transmitted positional information (Step S3-6).

If, on the other hand, worker retrieval response information that includes the mobile station identification information of the mobile station D1 is not received within the predetermined time in the worker retrieval process, the data collection unit 10 determines that the mobile station D1 cannot be detected (Step S3-5).

Then, the data collection unit 10 assumes that the mobile station D1 has moved away from the management area and computes the sojourn time of the mobile station D1 in the management area (Step S3-7).

Then, the data collection unit 10 outputs an alarm (Step S3-8) and additionally registers data on the situation to the intra-structure moving history data (Step S3-9). Then, it clears the current position of the mobile station D1 (Step S3-10).

FIGS. 14 and 15 show examples of management chart that can be displayed on the display 3 of the central moving object monitoring means A.

FIG. 14 is a schematic illustration of an exemplar map of the entire area that is under control.

In this instance, the number of persons currently staying in the underground structure, the status of the data collection PC (data collection unit 10) (normal or abnormal), the status of the remote I/O (normal or abnormal), the status of the gate PC (management terminal unit 20) and the status of each management area (normal or abnormal) are displayed at the left side of the display screen and a gallery map is displayed at the right side of the display screen.

In this instance, five management areas and a single passing point are provided for the galleries and the five management areas 1 through 5 are indicated respectively by five square graphic symbols, where the single passing point 1 is indicated by a circular graphic symbol.

Additionally, in the instance of FIG. 14, the display screen shows that the gate PC (management terminal unit 20) is in an abnormal status and “abnormal” is displayed at a side of the gate PC (management terminal unit 20) in a color different from the color for “normal” (e.g., red).

Furthermore, in the instance of FIG. 14, the display screen shows that the management area 3 is in an abnormal status and “management area—3” is displayed at the left side in a color different from the color for “normal (e.g., red), and the square graphic symbol that corresponds to the management area 3 on the map on the left side is displayed in a color different from the color for normal (e.g., red).

FIG. 15 is a schematic illustration of the display screen where the map at the right side in FIG. 14 is switched to an enlarged map of the management area 3.

When an enlarged map of a management area is displayed, the number of workers staying in the management area is displayed above it and a list of the wireless IDs of the workers, the names of the workers and so on are also displayed as detailed information.

Thus, the enlarged map of the management area is displayed under the list and the underground base stations (underground base stations for entrance/exit of management areas and underground base stations for management areas) in the management area are indicated by respective circular graphic symbols, while the workers staying in the service area of each of the underground base stations are indicated by so many square graphic symbols. Each of the square graphic symbols representing the workers contains therein the ID number of the mobile station that the worker carries.

When any of the mobile stations falls in an abnormal status, the central monitoring unit 1 displays the underground base station that detects the abnormality or the mobile station in a color different from the color for normal.

In this instance, the underground base station 10 (an underground base station for entrance/exit of management areas) is in an abnormal status.

The system for monitoring positions of moving objects of this instance has the following features in addition to the function of executing the above processes.

The CPU 60 of each mobile station D transmits detection information on its oscillation sensor 65 along with periodically transmitted positional information.

The CPU 60 of each mobile station D transmits detection information on its tilt sensor 66 along with periodically transmitted positional information.

The CPU 41 of each underground base station 40 combines the periodically transmitted positional information, the detection information on the oscillation sensor 65 and the tilt sensor 65 received from each mobile station D and its own base station identification number and transmits the combined information to the central moving object monitoring means A through an optical cable.

The detection information on the oscillation sensors 65 and the tilt sensors 66 transmitted from each underground base means C is received by the data collection unit 10 along with the periodically transmitted positional information and the data collection unit 10 accumulates the received pieces of information sequentially in the central monitoring unit 1.

If the value of the detection information on the oscillation sensor 65 or the tilt sensor 66 that the central monitoring unit 1 receives by way of the data collection unit 10 exceeds a predetermined value, the central monitoring unit 1 determines that the worker who carries the corresponding mobile station D falls in an abnormal status. Then, it issues an alarm by way of the display and a speaker (not shown) to notify the abnormal status and displays the position of the mobile station D that is in an abnormal status on the management chart.

Each mobile station D is so designed that it can transmit appropriately prepared data along with its mobile station identification number by way of the man-machine interface 67.

The appropriately prepared data and the mobile station identification number transmitted from the mobile station D are received by the underground base means C whose sensing area covers the mobile station D and, upon receiving the information, the underground base means C transmits appropriately prepared information containing the transmitted information and the base station identification number in combination to the central moving object monitoring means A by way of an optical cable.

The appropriately prepared information (appropriately prepared data+mobile station identification number+base station identification number) transmitted from the underground base means C is received by the data collection unit 10. The data collection unit 10 accumulates the received pieces of information sequentially in the central monitoring unit 1. The central monitoring unit 1 displays necessary information on the display 12, utilizing the pieces of appropriately prepared information accumulated in the central monitoring unit 1.

The data to be contained in the appropriately prepared information may be appropriately defined according to the intention of the users of the system for monitoring positions of moving objects. For example, each mobile station D may be provided with an appropriate number of appropriately prepared information transmission switches 63 for different types of appropriately prepared information so that the contents of the appropriately prepared information transmitted from a mobile station D may be sorted by seeing the kind of switches 63 which transmitted said prepared information. Additionally, each mobile station D may be provided with a keyboard as the man-machine interface 67 and adapted to transmit the character data input from the keyboard as appropriately prepared data. Still additionally, each mobile station D may be provided with a camera and the image data obtained by the camera may be transmitted as appropriately prepared data.

The central monitoring unit 1 of the central moving object monitoring means A is so designed that it can transmit appropriately prepared information individually or collectively to the mobile stations D by way of the underground base means C.

On the other hand, each mobile station is so designed that it receives only information that includes its mobile station identification number. Similarly, each underground base station is so designed that it receives only information that includes its base station identification number.

As pointed out above, the central monitoring unit 1 grasps the position in the underground structure where each underground base means C is arranged and can find out the underground base means C whose sensing area covers a given mobile station D.

Referring to FIG. 16, when the manager using the central moving object monitoring means A transmits appropriately prepared information individually to a certain mobile station D in the underground structure, he or she adds the mobile station identification number of the mobile station D and the base station identification number of the underground base means C whose sensing area covers the mobile station D to the appropriately prepared information to be transmitted before actually transmitting the information from the central monitoring unit 1 to the underground base means C.

The signal transmitted from the central monitoring unit 1 is received by the underground base station 40 of the underground base means C having the base station identification number by way of the data collection unit 10 and the base station 40 that receives the signal then transmits the mobile station identification number and the individually transmitted information that are transmitted to it by way of the data collection unit 10 from the central monitoring unit 1 by means of the wireless transmitter/receiver set 42.

The signal transmitted from the base station 40 is received by the mobile station D having the mobile station identification number and the mobile station 30 that receives the signal then displays the individually transmitted information by way of the LED 62, the buzzer 64, the oscillator 71 and/or the man-machine interface 67.

When, on the other hand, transmitting appropriately prepared information collectively to all the mobile stations D at a time from the central monitoring unit 1 through the data collection unit 10, the manager adds the base station identification numbers of all the base stations and the mobile station identification numbers of all the mobile stations to the information to be collectively transmitted before actually transmitting the information from the central monitoring unit 1 to the underground base means C.

The signal transmitted from the central monitoring unit 1 byway of the data collection unit 10 is received by all the base stations 40 of all the underground base means C and each of the base stations 40 that receives the signal then transmits the mobile station identification numbers and the collectively transmitted information of all the mobile stations D covered by its sensing area by means of the wireless transmitter/receiver set 42.

The signal transmitted from the base station 40 is received by all the mobile stations D covered by the sensing area of the base station 40 and each of the mobile stations D that receives the signal displays the received information that is collectively transmitted by way of the LED 62, the buzzer 64, the oscillator 71 and/or the man-machine interface 67.

The individually or collectively transmitted information transmitted from the central monitoring unit 1 by way of the data collection unit 10 may be appropriately prepared information. It may be information on occurrence of a danger, information on completion of a work or information on an alteration of a work.

With the above-described arrangement, the manager using the central moving object monitoring means A can constantly monitors the position of each of the mobile stations D in the underground structure and exchange information with each of the mobile stations D.

Additionally, the manager using the central moving objects monitoring means A can grasp not only the position but also the status of each of the mobile stations D according to the position information transmitted from the mobile station D by way of the corresponding underground base means C.

More specifically, for example, when the mobile stations D are not carried by workers but mounted on respective work vehicles and one of the mobile stations D does not move from a predetermined position for a predetermined period of time, it may be so determined that the work vehicle on which the mobile station D is mounted falls in an abnormal status.

While the manager may determine an abnormal status according to the positional information displayed at the central monitoring unit 1, it may alternatively be so arranged, if necessary, that the central monitoring unit 1 automatically determines the status and the result of determination may be displayed on the display.

As described above, the hub 52 of each of the underground base means C is connected to a remote I/O 53 in addition to an underground base station 40.

Each of the remote I/O 53 is provided with identification information such as an IP address and the relationship between the underground base station 40 and the remote I/O 53 of each of the underground base means C is recorded and managed by the central monitoring unit 1.

The remote I/O 53 tracking error of each of the underground base means C is connected to a gas detection sensor 50 and, when the sensor detects gas above a predetermined concentration level, it automatically transmits the detection signal from the gas detection sensor to the central moving object monitoring means A with its own identification information.

The abnormal concentration signal (remote I/O identification information +detection signal from the gas detection sensor) from the remote I/O is received by the data collection unit 10. The data collection unit 10 accumulates the received abnormal concentration signals sequentially in the central monitoring unit 1.

The central monitoring unit 1 displays the abnormal concentration signal recorded in the central monitoring unit 1 on the display.

The number of the management areas is not limited to those of the example and may be appropriately selected if necessary.

The number and the arrangement intervals of underground base means C are not limited to those of the example and may be appropriately selected according to the area of the priority position monitoring region to be provided and the coverage of each of the base stations to be used.

Additionally, while 400 MHz is employed for wireless communications between a mobile station D and a corresponding underground base means C in the above-described instance, the frequency band to be used for wireless communications is not limited to that of this instance and an appropriately selected frequency band may alternatively be employed. Examples of frequency band that can be used for the purpose of the present invention include 300 to 400 MHz band, 1.2 GHZ band and 2.4 GHz band.

While an 8-bit CPU is employed in each of the base stations 40 and each of the mobile stations Din the above-described instance, the number of bits of the CPU is by no means limited to the above value of this instance and a 16-bit or 32-bit CPU may alternatively be employed.

While the underground base means are connected to each other by way of optical cables in the above-described instance, the present invention is by no means limited to such an arrangement. Alternatively, for example, the underground base means C located closest to the entrance of the underground structure and the central moving object monitoring means A may be connected to each other by way of an optical cable and the remaining underground base means C may be wirelessly connected to each other and to the above underground base means C so that they may be able to communicate also with the central moving object monitoring means A.

While the central moving object monitoring means A and the underground base means C are connected to each other by way of optical cables in the above-described instance, the cables connecting the central moving object monitoring means A and the underground base means C are not limited to optical cables and any other cables may alternatively be employed so long as they can be used for data transmission and data reception.

The power supplies of the underground base means and the mobile stations are not limited to those described above and any other appropriate power supplies such as nicad batteries may alternatively be employed for them.

### BRIEF DESCRIPTION OF THE DRAWINGS

FIG. 1 is a schematic illustration of a system for monitoring positions of moving objects according to the present invention, showing the system configuration thereof.

FIG. 2 is a schematic block diagram of the system for monitoring positions of moving objects shown in FIG. 1.

FIG. 3 is a schematic illustration of an exemplar arrangement of sensor pairs for detecting entrance and exit of a worker.

FIG. 4 is a flowchart of the entrance management process of the access control means B.

FIG. 5 is a flowchart of the exit management process of the access control means B.

FIG. 6 is a schematic block diagram of an underground base station 40, showing the internal configuration thereof.

FIG. 7 is a schematic block diagram of a mobile station D to be carried by a worker entering the underground structure, showing the internal configuration thereof.

FIG. 8 is schematic illustration of an exemplar arrangement of underground base means C in an underground structure.

FIG. 9 is a schematic illustration of the contents of a signal transmitted from a mobile station and those of a signal transmitted from a corresponding base station.

FIG. 10 is a main flowchart of the process of monitoring the positions of moving objects.

FIG. 11 is a flowchart of the process for entrance/exit of management areas.

FIG. 12 is a flowchart of the process for management areas.

FIG. 13 is a flowchart of the missing worker monitoring process.

FIG. 14 is a schematic illustration of an exemplar management chart displayed on the display 3 of the central moving object monitoring means A.

FIG. 15 is a schematic illustration of another exemplar management chart displayed on the display 3 of the central moving object monitoring means A.

FIG. 16 is a schematic illustration of the contents of a signal transmitted from the central monitoring unit to the mobile stations by way of the base stations.

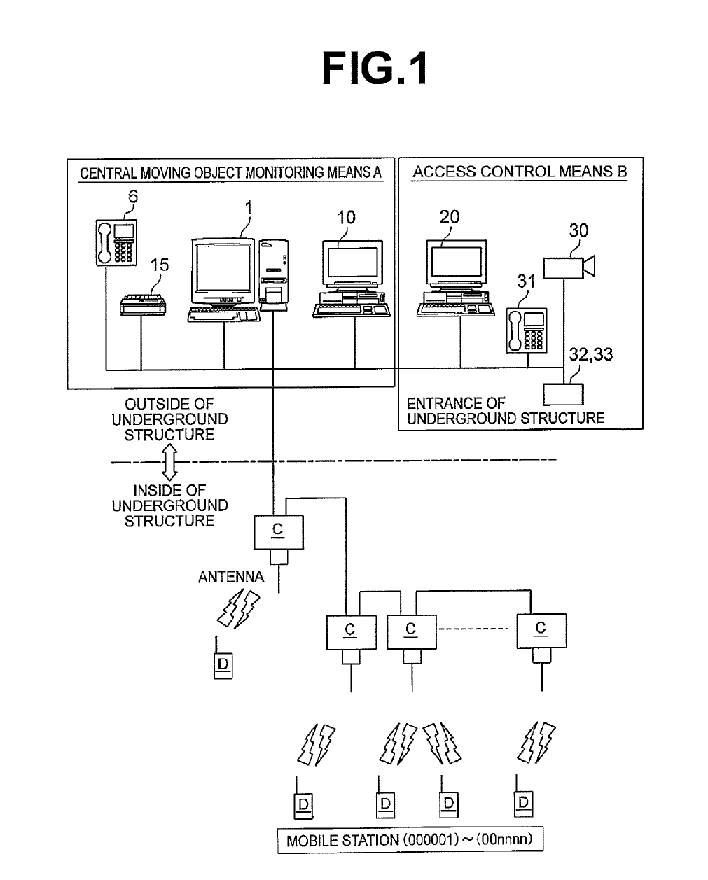

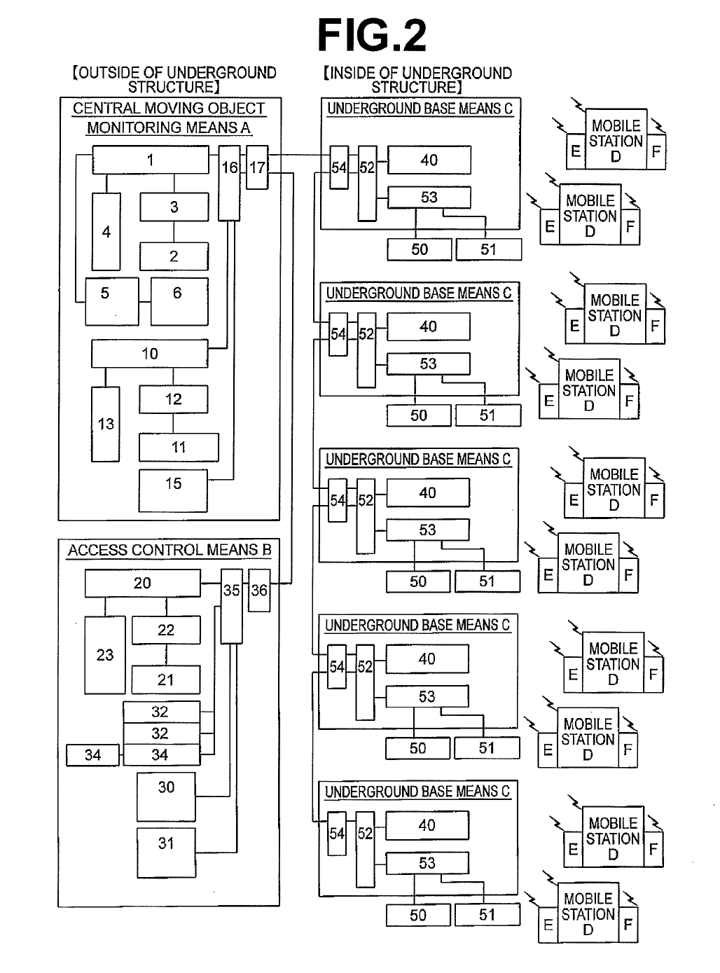

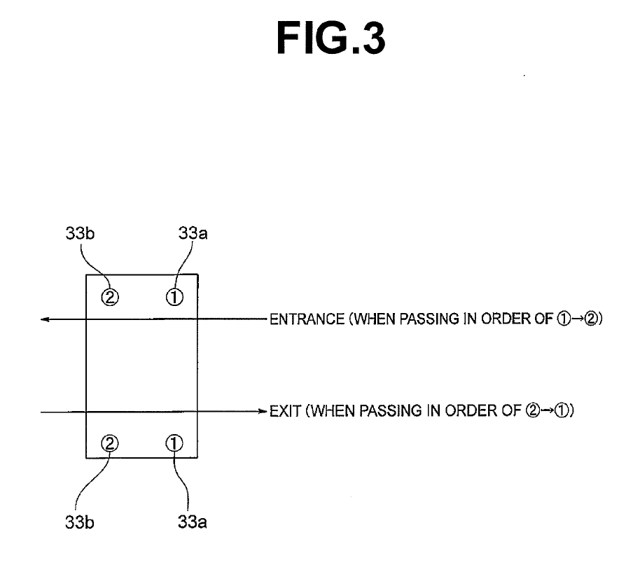

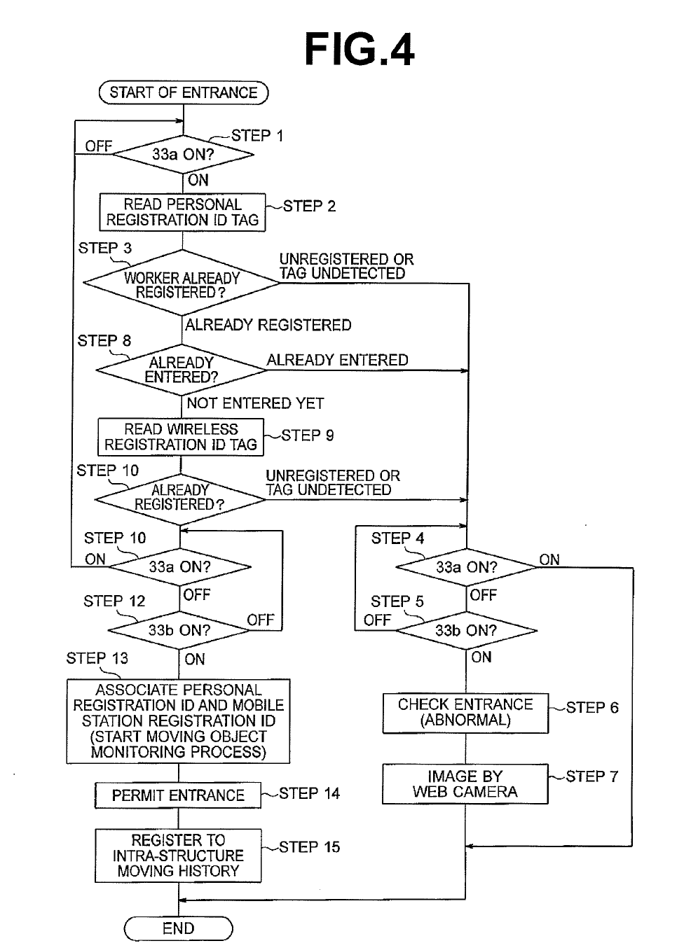

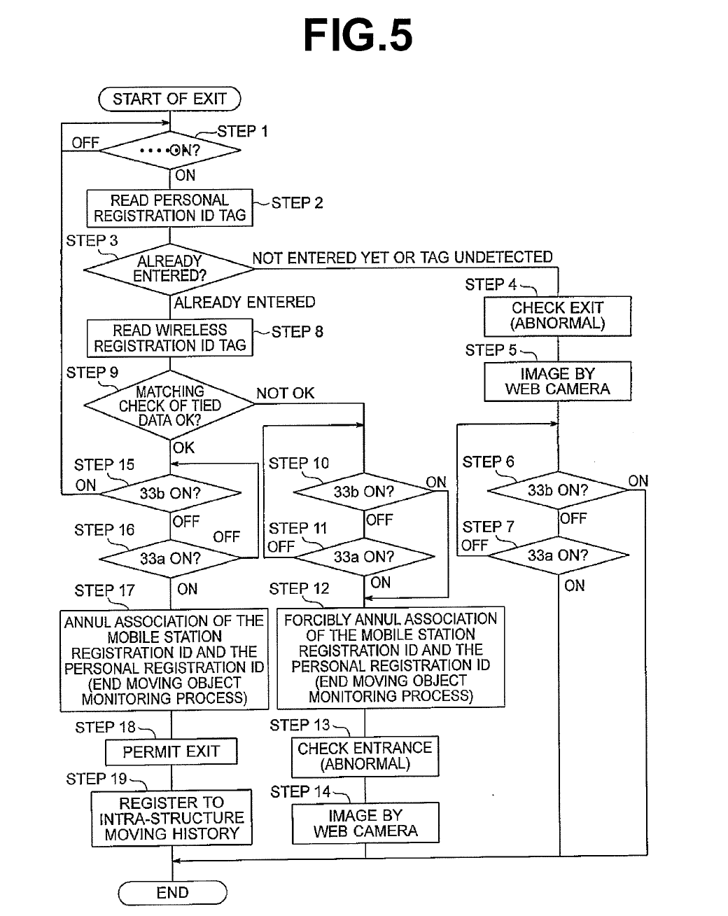

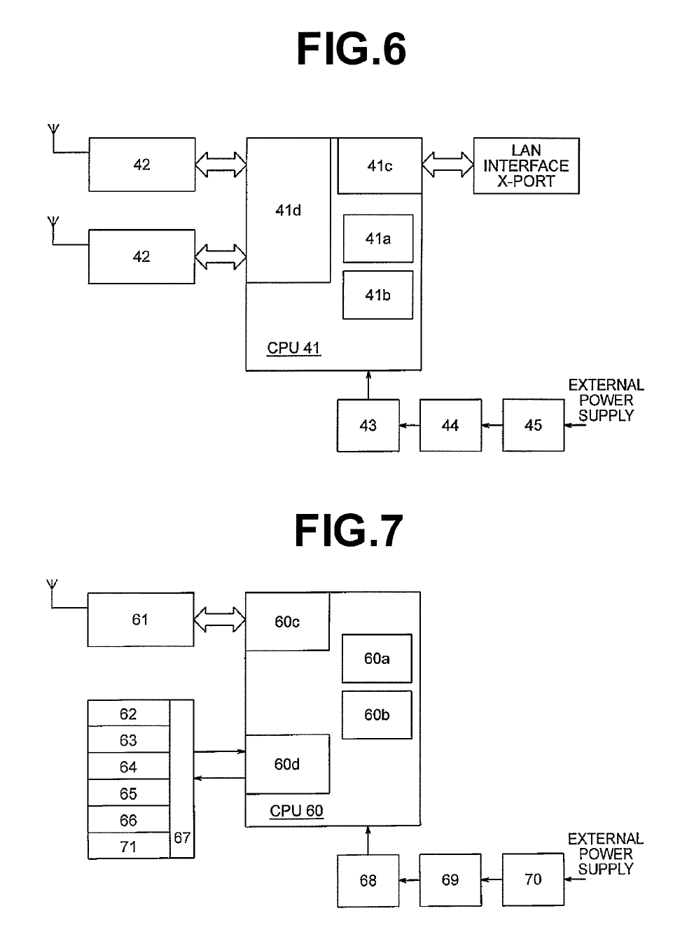

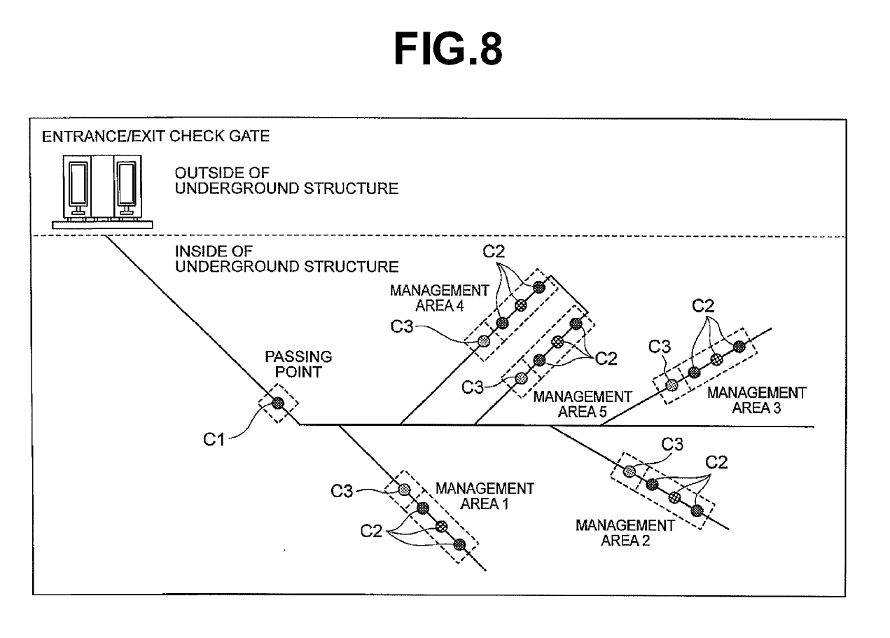

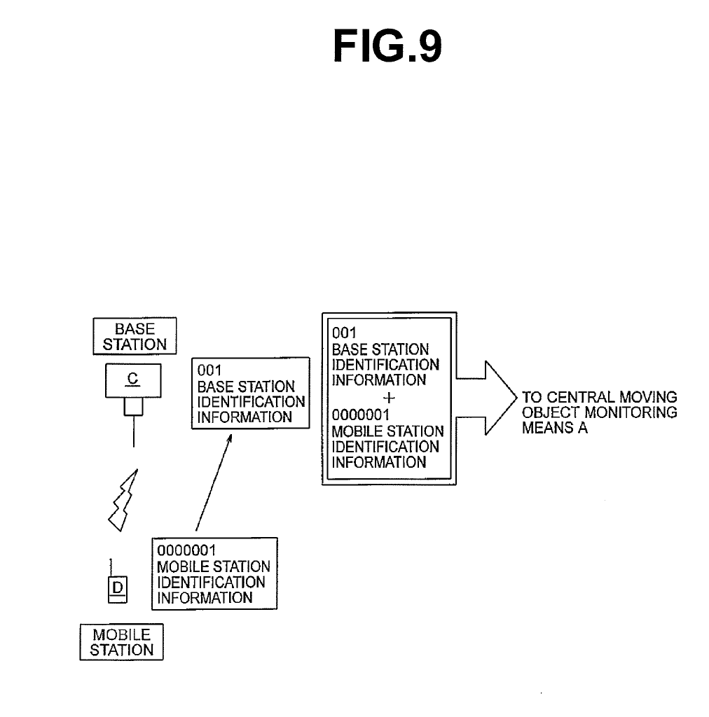

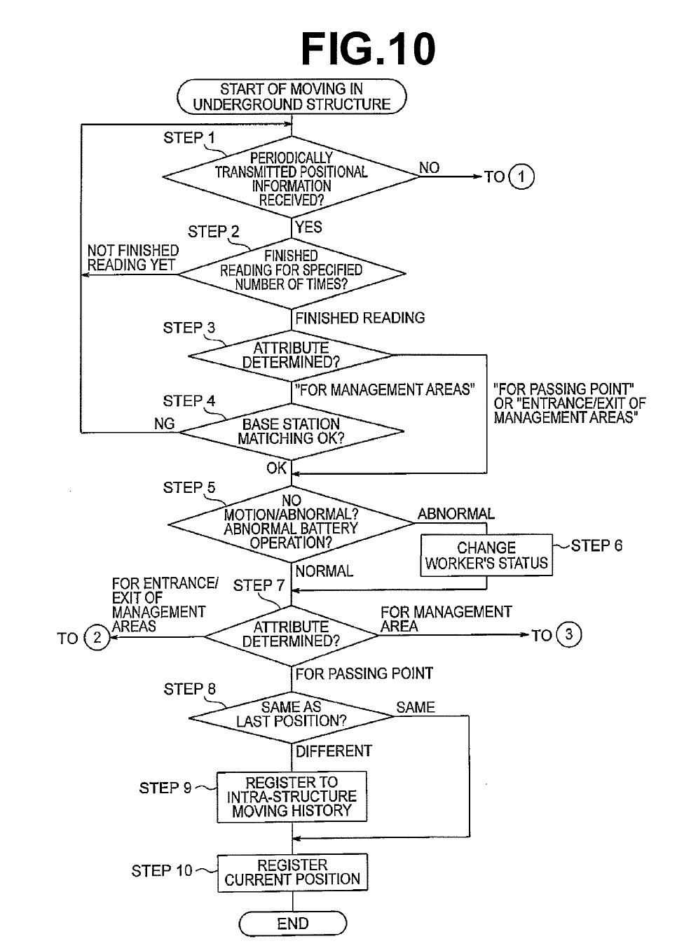

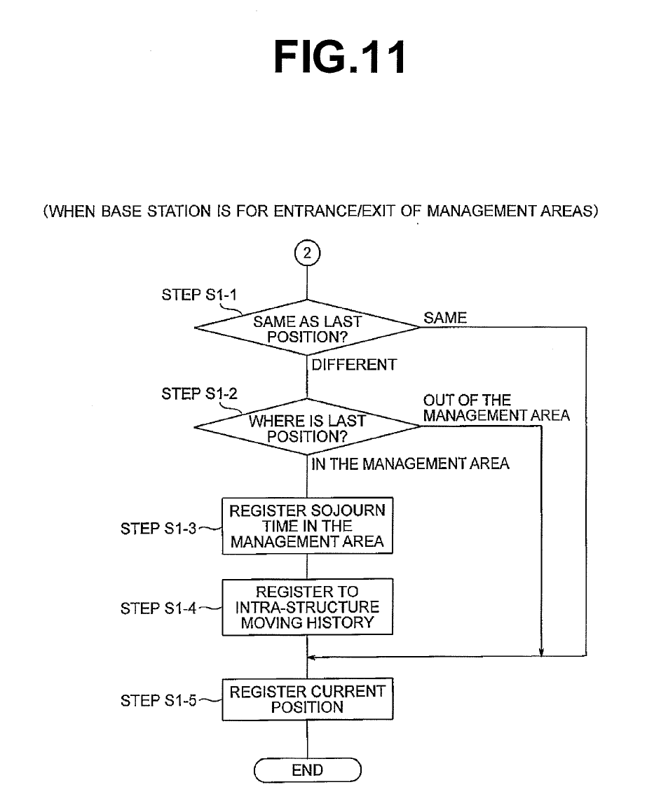

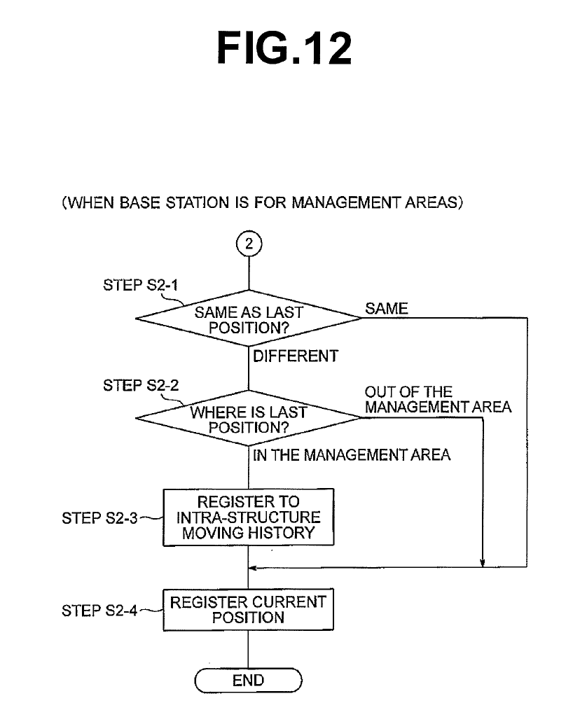

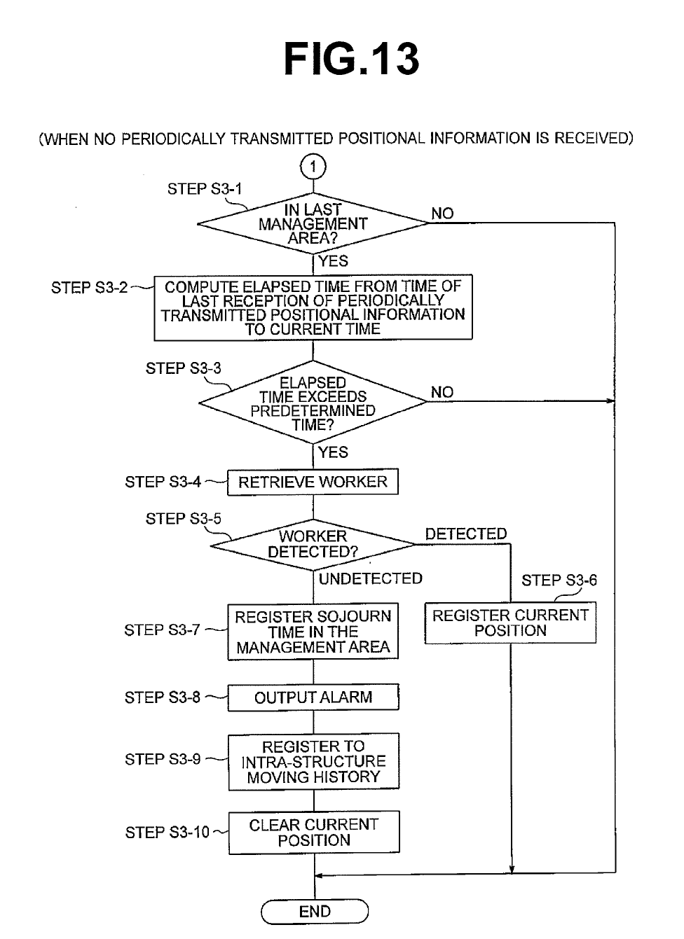

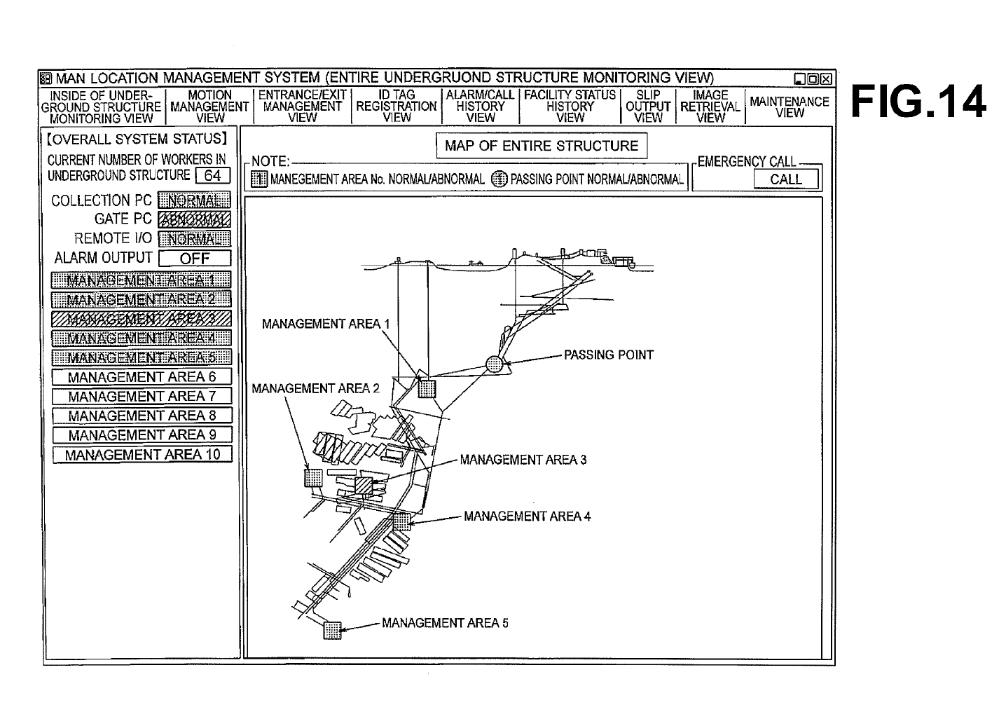

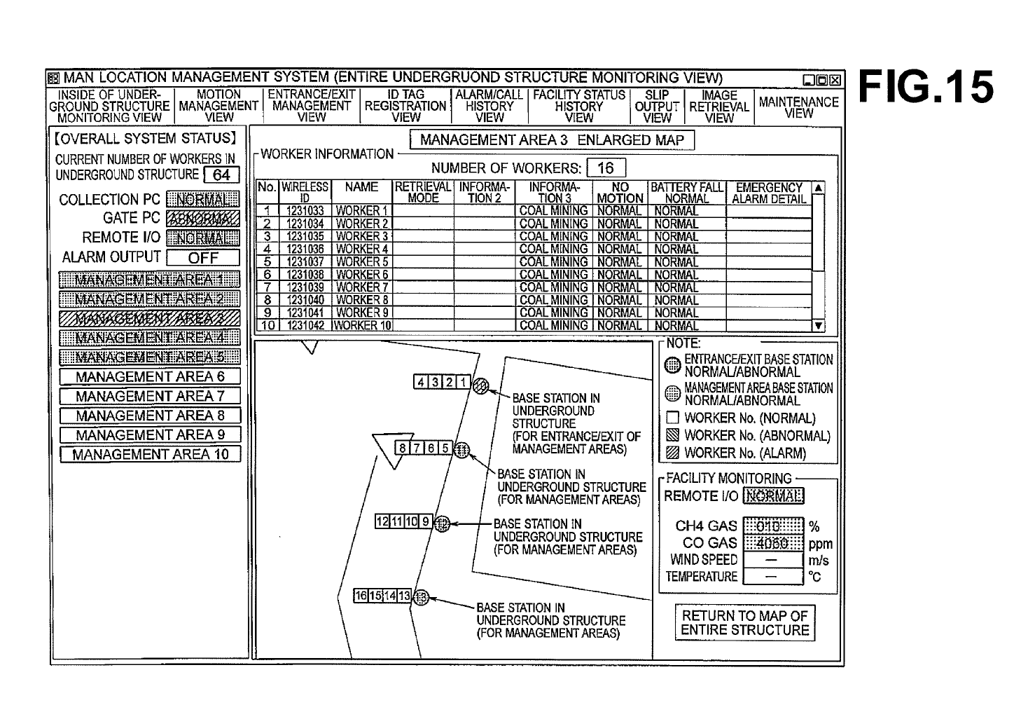

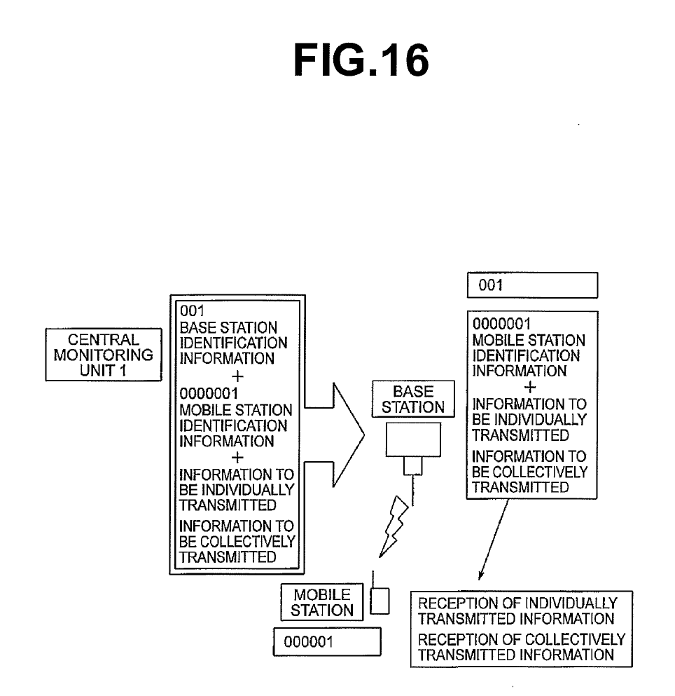

### EXPLANATION OF REFERENCE SYMBOLS

A: central moving object monitoring means
1: central monitoring unit
2: keyboard
3: display (CRT)
4: uninterruptible power supply (UPS)
5: communication control unit
6: IP phone
10: data collection unit
11: keyboard
12: display (CRT)
13: uninterruptible power supply (UPS)
15: printer
16: hub
17: media converter
B: access control means
20: management terminal unit
21: keyboard
22: display (CRT)
23: uninterruptible power supply (UPS)
30: web camera
31: IP phone
32: tag reader
33: sensor
34: remote I/O
35: hub
36: media converter
C: underground base means
40: underground base station
41: CPU
41a: built-in flash ROM
41b: built-in RAM
41c: wired interface
41d: wireless interface
42: unique format wireless transmitter/receiver set
43: regulator
44: lithium battery
45: charging circuit
50: gas detection sensor
51: monitor camera
52: hub
53: remote I/O
D: mobile station
60: CPU
60a: built-in flash ROM
60b: built-in RAM
60c: wired interface
60d: standard input/output port
61: unique format wireless transmitter/receiver set
62: LED
63: switch
64: buzzer
65: oscillation sensor
66: tilt sensor
67: man-machine interface
68: regulator
69: lithium battery
70: charging circuit
71: oscillator
E: tag

1. A system for monitoring positions of moving objects characterized in that the system comprises:
central moving object monitoring means arranged out of an underground structure;
mobile stations to be borne by respective human beings and/or some other moving objects; and
at least an underground base means arranged within a control region in the underground structure,
that each of the mobile stations is made to store in advance a specific piece of mobile station identification information and transmit the mobile station identification information of itself at regular time intervals as digital signal,
that the or each of the underground base means is made to store in advance a specific piece of base station identification information, receive the specific pieces of mobile station identification information transmitted from the mobile stations and transmit the received pieces of mobile station identification information and the base station identification information of itself to the central moving object monitoring means as positional information, and
that the central moving object monitoring means is made to store in advance the positions of installation of the underground base means and display the position of each of the mobile stations in the underground structure according to the positional information transmitted from the underground base means.

2. The system according to claim 1, characterized in
that each of the mobile stations is equipped with an oscillation sensor and adapted to transmit a detection signal of the oscillation sensor in addition to the mobile station identification information, and
that each of the underground base means is adapted to receive the mobile station identification information and the oscillation sensor detection signal transmitted from the mobile station and transmit the received mobile station identification information and oscillation sensor detection signal and the base station identification information of itself to the central moving object monitoring means.

3. The system according to claim 1, characterized in
that each of the mobile stations is equipped with a tilt sensor and adapted to transmit a detection signal of the tilt sensor in addition to the mobile station identification information, and
that each of the underground base means is adapted to receive the mobile station identification information and the tilt sensor detection signal transmitted from the mobile station and transmit the received mobile station identification information and tilt sensor detection signal and the base station identification information of itself to the central moving object monitoring means.

4. The system according to claim 1, characterized in
that each of the mobile stations is adapted to be able to transmit optional information prepared by combining the mobile station identification number of itself and optional data received by the mobile station, and
that each of the underground base means is adapted to receive the optional information and transmit the received optional information and the base station identification information of itself to the central moving object monitoring means.

5. The system according to claim 1, characterized in
that each of the mobile stations is adapted to receive only information including the mobile station identification number of itself,
that each of the underground base means is adapted to receive only information including the base station identification number of itself, and
that the central moving object monitoring means is adapted to be able to transmit specific transmission information prepared by combining an arbitrarily selected mobile station identification number, the base station identification information of the underground base means whose sensing area covers the mobile station of the mobile station identification number and optional data.

6. The system according to claim 1, characterized in that,
when the central moving object monitoring means receives successively for a plurality of times positional information containing same base station identification information and same mobile station identification information, the central moving object monitoring means finishes reading the positional information and finalizes the position of the corresponding mobile station according to the positional information.

7. The system according to claim 1, characterized in that
a management area for controlling with priority the persons or some other moving objects carrying respective mobile stations in the underground structure is determined in advance, and
that the underground base means includes:
underground base means for a passing point adapted to detect each mobile station passing a predetermined point in the underground structure;
underground base means for management areas adapted to detect the behavior of each mobile station in the management areas in the underground structure; and
underground base means for entrance/exit of management areas adapted to detect the entrance and exit of each mobile station in the management areas.

8. The system according to claim 7, characterized in that,
when the central moving object monitoring means does not receive positional information from a mobile station supposed to be in one of the management areas for more than a predetermined time, the central moving object monitoring means makes each of the underground base stations and the mobile station raise the transmission output power thereof and tries to detect the mobile station supposed to be in the management area.

9. The system according to claim 1, characterized in that,
when there is a mobile station whose positional information does not change for a predetermined period of time, the central moving object monitoring means determines that the mobile station is in a status of no motion/abnormal.
